(19) United States
(12) Patent Application Publication
(10) Pub. No.: US 2019/0344930 A1
(43) Pub. Date: Nov. 14, 2019

(54) TEMPERATURE CONTROLLED CONTAINER STORAGE SYSTEM

(71) Applicant: Haier US Appliance Solutions, Inc., Wilmington, DE (US)

(72) Inventor: Jeffrey Lynn Jessie, Taylorsville, KY (US)

(21) Appl. No.: 15/978,246

(22) Filed: May 14, 2018

(51) Int. Cl. B65D 25/04; A23L 3/36; B65D 81/34

(52) U.S. Cl. CPC B65D 25/04; A23L 3/36; B65D 2581/34; B65D 2525/28; B65D 81/34

(57) ABSTRACT

A temperature controlled container storage system includes a cabinet. A sealed system is operable to chill or warm one or more of a plurality of receptacles within the cabinet. A latch is operable to lock a door on the cabinet in a closed position. A plurality of collapsible containers is shaped such that each container of the plurality of collapsible containers is complementary to and receivable within a respective one of the plurality of receptacles. A height of each container of the plurality of collapsible containers in an unfolded configuration is greater than the height of each container of the plurality of collapsible containers in a collapsed configuration.

### FIELD OF THE INVENTION

The present subject matter relates generally to temperature controlled container storage systems.

### BACKGROUND OF THE INVENTION

Home delivery for various goods is increasingly popular. Consumers enjoy the convenience associated with home delivery. For example, consumers can order groceries online, and the groceries can be delivered to the consumers' house a short time later. However, home delivery faces challenges with certain types of goods.

For example, some goods require refrigeration. In particular, frozen food items can thaw and spoil if left outside a consumer's door for an extended period of time. Certain pharmaceuticals also require refrigeration. As another example, leaving goods unattended outside the consumer's door presents an opportunity for theft.

A secure temperature controlled storage system would be useful to address these challenges.

### BRIEF DESCRIPTION OF THE INVENTION

The present subject matter provides a temperature controlled container storage system with a cabinet. A sealed system is operable to chill or warm one or more of a plurality of receptacles within the cabinet. A latch is operable to lock a door on the cabinet in a closed position. A plurality of collapsible containers is shaped such that each container of the plurality of collapsible containers is complementary to and receivable within a respective one of the plurality of receptacles. A height of each container of the plurality of collapsible containers in an unfolded configuration is greater than the height of each container of the plurality of collapsible containers in a collapsed configuration. Additional aspects and advantages of the invention will be set forth in part in the following description, or may be apparent from the description, or may be learned through practice of the invention.

In a first example embodiment, a temperature controlled container storage system includes a cabinet that defines a plurality of receptacles. A sealed system is disposed within the cabinet. The sealed system is operable to chill or warm one or more of the plurality of receptacles. A door is mounted to the cabinet. The door is adjustable between an open position and a closed position. The door blocks access to the plurality of receptacles in the closed position. A latch is operable to lock the door in the closed position. A plurality of collapsible containers is shaped such that each container of the plurality of collapsible containers is complementary to and receivable within a respective one of the plurality of receptacles. Each container of the plurality of collapsible containers is adjustable between an unfolded configuration and a collapsed configuration. A height of each container of the plurality of collapsible containers in the unfolded configuration is greater than the height of each container of the plurality of collapsible containers in the collapsed configuration.

In a second example embodiment, a temperature controlled container storage system includes a cabinet that defines a plurality of receptacles with a refrigerated receptacle and a freezer receptacle. A sealed system is disposed within the cabinet. The sealed system is operable to chill the freezer receptacle to a temperature less than the freezing temperature of water. The sealed system is also operable to chill the refrigerated receptacle to a temperature greater than the freezing temperature of water and less than an ambient temperature about the cabinet. A door is mounted to the cabinet. The door is adjustable between an open position and a closed position. The door blocks access to the plurality of receptacles in the closed position. A latch is operable to lock the door in the closed position. A plurality of collapsible containers includes a refrigerated container and a freezer container. The plurality of collapsible containers is commonly sized and shaped such that each container of the plurality of collapsible containers is complementary to and receivable within a respective one of the plurality of receptacles. Each container of the plurality of collapsible containers is adjustable between an unfolded configuration and a collapsed configuration. A height of each container of the plurality of collapsible containers in the unfolded configuration is at least four times greater than the height of each container of the plurality of collapsible containers in the collapsed configuration. Each receptacle of the plurality of receptacles having a volume no greater than two cubic feet. Each container of the plurality of collapsible containers defining an internal storage volume in the unfolded configuration. Each container of the plurality of collapsible containers sized to fit within the respective one of the plurality of receptacles in the unfolded configuration.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a perspective view of a temperature controlled container storage system according to an example embodiment of the present subject matter.

FIG. 2 is a perspective view of the example temperature controlled container storage system of FIG. 1 with a collapsible container shown partially extended from a receptacle of a cabinet.

FIG. 3 is a perspective view of a collapsible container shown in an unfolded configuration.

FIG. 4 is a perspective view of a stack of collapsible containers of the example temperature controlled container storage system of FIG. 1.

FIG. 5 is a perspective view of a collapsible container shown in a collapsed configuration.

FIG. 6 is a schematic view of certain components of the example temperature controlled container storage system of FIG. 1.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

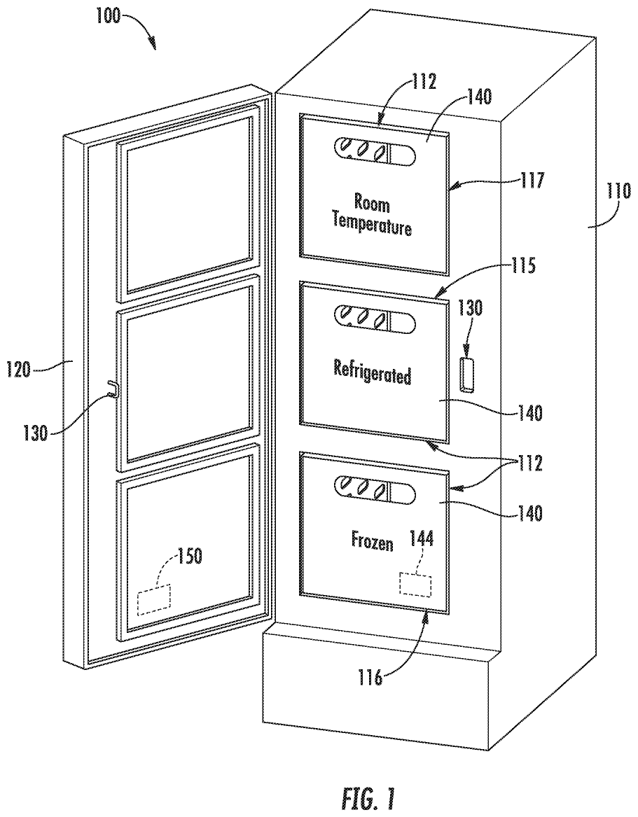

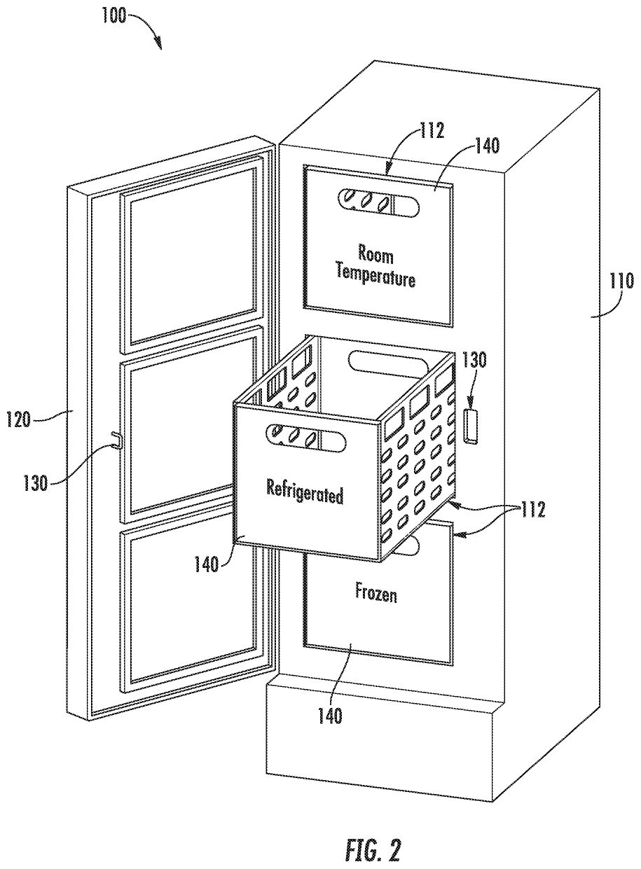

FIGS. 1 and 2 are perspective views of a temperature controlled container storage system 100 according to an example embodiment of the present subject matter. As may be seen in FIGS. 1 and 2, temperature controlled container storage system 100 includes a cabinet 110. Cabinet 110 defines a plurality of receptacles 112 within cabinet 110. Although shown with three receptacles 112, cabinet 110 may define two, four, five, or more receptacles 112 in alternative example embodiments.

A door 120 is mounted to cabinet 110. Door 120 is selectively adjustable between an open position (shown in FIGS. 1 and 2) and a closed position. Door 120 is positioned such that door 120 blocks access to receptacles 112 in the closed position, by covering and being positioned over receptacles 112. Door 120 may be hinged to cabinet 110 such that door rotates between the open and closed positions. In alternative example embodiments, door 120 may be slidably mounted to cabinet 110 such that door slides between the open and closed positions. A latch 130 is operable to lock door 120 in the closed position. Thus, latch 130 may hold door 120 in the closed position to prevent or limit unauthorized access to receptacles 112 within cabinet 110.

Temperature controlled container storage system 100 also includes a plurality of collapsible containers 140. Collapsible containers 140 are shaped such that each collapsible container 140 is complementary to and receivable within a respective one of receptacles 112. Thus, e.g., as shown in FIGS. 1 and 2, collapsible containers 140 may slide into and out of receptacles 112.

Collapsible containers 140 may be loaded with goods and stored within cabinet 110 in receptacles 112. In certain example embodiments, each receptacle 112 may have a volume no greater than two cubic feet (2 ft³), and each collapsible container 140 may be sized to fit within receptacle 112 when unfolded. Such sizing of receptacles 112 and collapsible containers 140 may advantageously provide sufficient space for good storage within cabinet 110 while avoiding overly large heated and/or cooled spaces within cabinet 110.

Temperature controlled container storage system 100 includes features for facilitating secure storage of delivered goods at a delivery location, such as a residence or business. As an example, a delivery service may load goods, such as groceries, pharmaceuticals, take-out, etc., into one or more of collapsible containers 140. Each loaded collapsible containers 140 may be positioned with one of receptacles 112. The delivery service may then close door 120 such that latch 130 holds door 120 in the closed position. Door 120 may then be unlocked by an authorized user, as discussed in greater detail below.

Temperature controlled container storage system 100 also includes features for storing the loaded collapsible containers 140 at a suitable temperature within cabinet 110. Thus, e.g., frozen items within one of collapsible containers 140 may be stored at or below freezing, refrigerated items within one of collapsible containers 140 may be stored above freezing and below ambient, and non-perishable items within one of collapsible containers 140 may be stored at ambient. It will be understood that temperature controlled container storage system 100 may be positioned within a freezing environment. Thus, e.g., non-perishable items, pharmaceutical, etc. within one of collapsible containers 140 may be stored at a temperate condition above freezing.

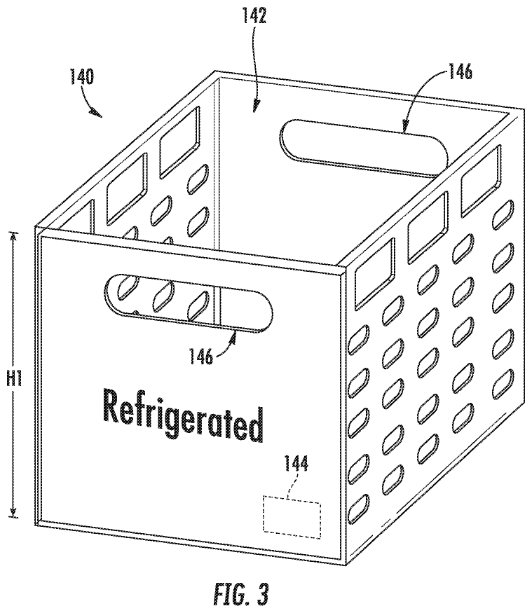

FIG. 3 is a perspective view of one of collapsible containers 140 in an unfolded configuration, and FIG. 5 is a perspective view of one of collapsible containers 140 in a collapsed configuration. Each collapsible container 140 is adjustable between the unfolded configuration (FIG. 3) and the collapsed configuration (FIG. 5). Collapsible containers 140 may be shifted to the unfolded configuration when used to store items within collapsible containers 140. In contrast, collapsible containers 140 may be shifted to the collapsed configuration for storage.

A height of collapsible containers 140 changes between the unfolded and collapsed configurations. In particular, the height H1 (FIG. 3) of collapsible containers 140 in the unfolded configuration is greater than the height H2 (FIG. 5) of collapsible containers 140 in the in the collapsed configuration. As an example, the height H1 of collapsible containers 140 in the unfolded configuration may be no less than four times greater than the height H2 (FIG. 5) of collapsible containers 140 in the in the collapsed configuration, in certain example embodiments. Such relative sizing of collapsible containers 140 between the unfolded and collapsed configurations can advantageously facilitate storage of collapsible containers 140 when not in use.

Collapsible containers 140 may be commonly sized. Thus, collapsible containers 140 may advantageously be fit within each receptacle 112. In addition, collapsible containers 140 may be utilized across various temperature controlled container storage systems 100. For example, a delivery service may have a supply of collapsible containers 140 that fits within cabinets 110 at various delivery locations. Thus, collapsible containers 140 may be interchangeable between temperature controlled container storage systems 100.

Each collapsible container 140 may also define an internal storage volume 142 in the unfolded configuration. Internal storage volume 142 may be sized for storing various items. As an example, internal storage volume 142 may be no greater than two cubic feet (2 ft³). Such sizing of internal storage volume 142 may advantageously allow common grocery items, such as a gallon of milk, a frozen pizza, soda bottles, laundry detergent, etc., to be stored within collapsible containers 140, without being overly large. Thus, collapsible containers 140 may be suitably sized for delivery services to deliver sundry items.

In certain example embodiments, each collapsible container 140 includes an embedded tag 144. Embedded tag 144 is operable to transmit storage condition information. For example, a tag reader 150 within cabinet 110 may read each embedded tag 144 as collapsible containers 140 are inserted into receptacles 112. As noted above, each collapsible container 140 may be stored at a suitable temperature within cabinet 110. Thus, e.g., if each collapsible container 140 within receptacles 112 contains non-perishable items, receptacles 112 may be kept at ambient rather than being chilled. In contrast, if one of collapsible container 140 contains frozen items, the collapsible container 140 with frozen items may be stored below freezing within a respective receptacle 112. Alternatively, the deliverer may be alerted if the collapsible container 140 with frozen items is inserted into an ambient or refrigerated receptacle 112. Thus, embedded tags 144 may communicate the appropriate storage temperature for each collapsible container 140. Embedded tag 144 may be a radio frequency identification tag, a near field communication tag, etc. Collapsible containers 140 may also be color coded and/or labeled to communicate storage condition information to the deliverer.

As shown in FIG. 3, each collapsible container 140 defines a handle 146. For example, opposing sidewalls of collapsible containers 140 may each define a hole sized for receiving a hand. Handle 146 may allow more easy handling of collapsible container 140 relative to containers without handles.

Collapsible container 140 in FIG. 3 is labeled “Refrigerated” and may be used to store refrigerated items. To reduce heating of refrigerated items, collapsible containers 140 may have insulated walls. For example, collapsible container 140 may include walls with reflective insulation panels, polystyrene insulation panels, etc. Collapsible containers 140 may have insulated walls to reduce cooling of hot items.

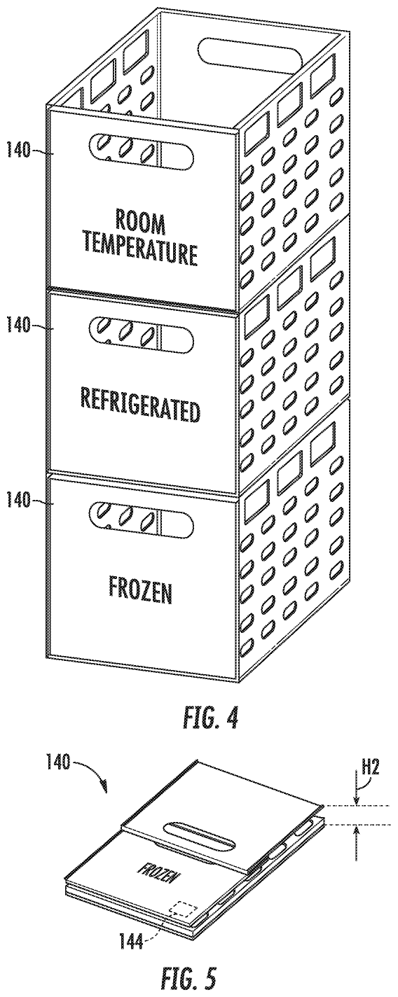

FIG. 4 is a perspective view of a stack of collapsible containers 140. As may be seen in FIG. 4, collapsible containers 140 are stackable on one another in the unfolded configuration. Thus, e.g., collapsible containers 140 may be easily transported and stored outside of cabinet 110.

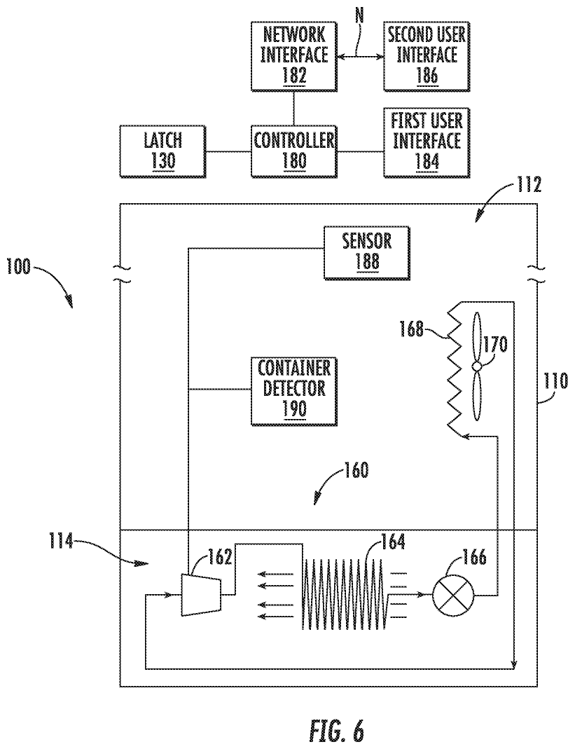

FIG. 6 is a schematic view of certain components of temperature controlled container storage system 100, including a sealed refrigeration system 160. A machinery compartment 114 of cabinet 110 contains components for executing a known vapor compression cycle for cooling air. The components include a compressor 162, a condenser 164, an expansion device 166, and an evaporator 168 connected in series and charged with a refrigerant. As will be understood by those skilled in the art, refrigeration system 160 may include additional components, e.g., at least one additional evaporator, compressor, expansion device, and/or condenser. As an example, refrigeration system 160 may include two or more additional evaporators, each positioned at a respective one of receptacles 112. In addition, refrigeration system 160 may be operable as a heat pump to heat receptacles 112.

Within refrigeration system 160, refrigerant flows into compressor 162, which operates to increase the pressure of the refrigerant. This compression of the refrigerant raises its temperature, which is lowered by passing the refrigerant through condenser 164. Within condenser 164, heat exchange with ambient air takes place so as to cool the refrigerant. A fan (not shown) may be used to pull air across condenser 164 so as to provide forced convection for a more rapid and efficient heat exchange between the refrigerant within condenser 164 and the ambient air. Thus, as will be understood by those skilled in the art, increasing air flow across condenser 164 can, e.g., increase the efficiency of condenser 164 by improving cooling of the refrigerant contained therein. In alternative example embodiments, condenser 164 may operate with natural convection as opposed to forced convection.

An expansion device (e.g., a valve, capillary tube, or other restriction device) 166 receives refrigerant from condenser 164. From expansion device 166, the refrigerant enters evaporator 168. Upon exiting expansion device 166 and entering evaporator 168, the refrigerant drops in pressure. Due to the pressure drop and/or phase change of the refrigerant, evaporator 168 is cool relative to receptacles 112. As such, cooled air is produced and refrigerates one or more of receptacles 112. Thus, evaporator 168 is a type of heat exchanger which transfers heat from air passing over evaporator 168 to refrigerant flowing through evaporator 168. A fan 170 is used to pull air across evaporator 168 so as to provide forced convection for a more rapid and efficient heat exchange between the refrigerant within evaporator 168 and air within receptacles 112. Thus, as will be understood by those skilled in the art, increasing air flow across evaporator 168 can, e.g., increase the efficiency of evaporator 168 by improving heat transfer to the refrigerant contained therein. In alternative example embodiments, sealed system 160 does not include fan 170, and the heat transfer may occur using a cold wall methodology, such as used in chest freezers.

Collectively, the vapor compression cycle components in a refrigeration circuit, associated fans, and associated compartments are sometimes referred to as a sealed refrigeration system operable to force cold air through receptacles 112. The refrigeration system 160 depicted in FIG. 6 is provided by way of example only. Thus, it is within the scope of the present subject matter for other configurations of the refrigeration system to be used as well. For example, magneto-caloric or other suitable refrigeration system may be used to chill receptacles 112 in alternative example embodiments.

One or more of receptacles 112 may be a chilled receptacle, such as a refrigerated receptacle 115 (FIG. 1) or a freezer receptacle 116 (FIG. 1), and receptacles 112 may also include an ambient receptacle 117. Sealed system 160 may be operable to chill only the chilled receptacle, e.g., refrigerated receptacle 115 and/or freezer receptacle 116, while the other receptacles 112, e.g., ambient receptacle 117, are isolated from chilling by the sealed system 160 and remain at the ambient temperature about cabinet 110. In particular, sealed system 160 may be operable to chill freezer receptacle 116 to a temperature less than the freezing temperature of water, sealed system 160 may also be operable to chill refrigerated receptacle 115 to a temperature greater than the freezing temperature of water and less than an ambient temperature about cabinet 110. Cabinet 110 may include various air flow ducts, dampers, fans, heat exchangers, etc., for chilling each receptacle 112 to a respective temperature.

While described above as cooling receptacles 112, temperature controlled container storage system 100 may also include components for heating receptacles 112 in alternative example embodiments. Thus, e.g., temperature controlled container storage system 100 may include heating elements, such as electric heating elements, to allow refrigerated receptacle 115 and/or freezer receptacle 116 to be heated to an appropriate temperature, e.g., when the ambient temperature is below the set point temperature of such receptacles 112. As another example, sealed system 160 may include evaporators, such as evaporator 168, to heat receptacles 112. As yet another example, sealed system 160 may include one or more reversing valves for reversing fluid flow within sealed system 160 and thus switching operation of the heat exchangers within cabinet 110. Using a heating element or sealed system 160, one or more of receptacles 112 may be a warmed receptacle, such as may be used to keep cooked foods warm until removed by the user of temperature controlled container storage system 100.

As may be seen in FIG. 6, temperature controlled container storage system 100 may include a computing device or controller 180 and a network interface 182. Controller 180 is operatively coupled or in communication with various components of temperature controlled container storage system 100. The components include, e.g., compressor 162 of sealed system 160 and fan 170, etc. Controller 180 can selectively operate compressor 152 in order to supply refrigerant to evaporator 168 and condenser 164 and cool receptacles 112.

Controller 180 may be positioned in a variety of locations throughout temperature controlled container storage system 100. For example, controller 180 may be disposed in cabinet 110. Input/output (“I/O”) signals may be routed between controller 180 and various operational components of temperature controlled container storage system 100. The components of temperature controlled container storage system 100 may be in communication with controller 160 via one or more signal lines or shared communication busses.

Temperature controlled container storage system 100 may also include a first user interface 184. First user interface 184 may be mounted on cabinet 110, door 120 or at any other suitable location on refrigerator appliance 100. First user interface 184 is in communication with controller 180 such that first user interface 184 may send to and receive signals from controller 180. As an example, controller 180 may receive signals from first user interface 184 corresponding to input commands from a user of temperature controlled container storage system 100. First user interface 184 may include, for example, a touchscreen interface, a near field communication reader, a QR-code reader, etc.

Network interface 182 may couple temperature controlled container storage system 100, e.g., controller 180, to a network (labeled with arrow N) such that temperature controlled container storage system 100 can transmit and receive information over the network. The network can be any wired or wireless network such as a WAN, LAN, and/or HAN. Network interface 182 can include any circuitry or components for communication over the network. For example, controller 180 can use network interface 182 to communicate with a second user interface 186. Network interface 182 may include transmitters, receivers, ports, controllers, antennas, or other suitable components for interfacing with the network.

Temperature controlled container storage system 100, e.g., controller 180, is in communication with second user interface 186 via the network. Second user interface 196 can be any device configured to communicate over the network and allow a user to remotely generate and transmit command signals to controller 180. For example, second user interface 186 may be a computer, a smartphone, a tablet, etc. Second user interface 186 is in communication with controller 180 such that second user interface 186 and controller 180 may transmit signals and data therebetween. Second user interface 186 can also include a network interface, e.g., constructed in the same or similar manner to network interface 182, that allows second user interface 186 to initiate communications with temperature controlled container storage system 100 over the network.

Controller 180 can be any device that includes one or more processors and a memory. As an example, in some embodiments, controller 180 may be a single board computer (SBC). For example, controller 180 can be a single System-On-Chip (SOC). However, any form of controller 180 may also be used to perform the present subject matter. The processor(s) can be any suitable processing device, such as a microprocessor, microcontroller, integrated circuit, or other suitable processing devices or combinations thereof. The memory can include any suitable storage media, including, but not limited to, non-transitory computer-readable media, RAM, ROM, hard drives, flash drives, accessible databases, or other memory devices. The memory can store information accessible by processor(s), including instructions that can be executed by processor(s) to perform aspects of the present disclosure.

As an example, controller 180 may also include a number of modules to provide functionality or otherwise perform particular operations. It will be appreciated that the term “module” refers to computer logic utilized to provide desired functionality. Thus, a module can be implemented in hardware, application specific circuits, firmware and/or software controlling a general purpose processor. In one embodiment, modules are program code files stored on the storage device, loaded into memory and executed by a processor or can be provided from computer program products, for example computer executable instructions, that are stored in a tangible computer-readable storage medium such as RAM, hard disk or optical or magnetic media.

Controller 180 is also in operative communication with latch 130. Thus, e.g., controller 180 may be configured for unlocking latch 130 in response to an opening signal received at controller 180. The opening signal may be generated at first user interface 184 or second user interface 186. Thus, a delivery service may open door 120 by interfacing with first user interface 184, e.g., such that first user interface 184 transmits the opening signal to controller 180 in response to the delivery service interacting with first user interface 184. In particular, the delivery service may input a password, scan a QR-code, an RFID or near field communication tag, etc. at first user interface 184 to authenticate the delivery service, and controller 180 may actuate latch 130 to open door 120 in response to the opening signal from first user interface 184. As another example, the delivery service may open door 120 by interfacing with second user interface 186, e.g., such that second user interface 186 transmits the opening signal to controller 180 in response to the delivery service interacting with second user interface 186. In particular, the delivery service may input a password at second user interface 186 to authenticate the delivery service, and controller 180 may actuate latch 130 to open door 120 in response to the opening signal from second user interface 186. In such a manner, latch 120 may be actuated in response to local authorization via first user interface 184 or in response to remote authorization via second user interface 186 in order to open door 120. Thus, door 120 may be advantageously unlocked by latch 130 via first and second user interfaces 184, 186, and collapsible containers 140 may be securely stored within cabinet 110. It will be understood that any other authorized user of system 100, such as the recipient of the delivery service, may locally or remotely operate latch 130 to open door 120 in the manner described above. Thus, e.g., the delivery service customer may utilize second user interface 186 to authenticate the delivery service, and controller 180 may actuate latch 130 to open door 120 in response to the opening signal from second user interface 186.

As noted above, controller 180 may be operative communication with sealed system 160. Controller 180 may be configured for activating sealed system 160 in response to an activation signal from network interface 182. For example, a delivery service may place collapsible containers 140 within receptacles 112, and a recipient may be notified of the delivery. The recipient may utilize second user interface 186 to remotely generate the activation signal, and the activation signal may be communicated to controller 180 via network interface 182. Controller 180 may activate compressor 162 in response to the activation signal. In such a manner, sealed system 160 may advantageously be deactivated and not consume valuable energy prior to delivery of the collapsible containers 140.

Controller 180 may also be in communication with a temperature sensor 188 within cabinet 110. Temperature sensor 188 may be a thermistor, thermocouple, etc. that is operable to measure the temperature of one or more of receptacles 112. Controller 180 may utilize signals from temperature sensor 188 to determine the temperature of receptacles 112. Controller 180 may also transmit the temperature of receptacles 112 to second user interface 186 via network interface 182. In such a manner, the recipient of delivered collapsible containers 140 in receptacles 112 may remotely monitor the temperature of receptacles 112. Remote monitoring of the temperature of receptacles 112 may allow the recipient to advantageously monitor undesirable temperature increases in receptacles 112. Thus, e.g., if freezer receptacle 116 is above the freezing temperature of water, the recipient of collapsible containers 140 may be alerted and take remedial action.

Controller 180 may also be in communication with a container detection sensor 190 within cabinet 110. Container detection sensor 190 may be an optical sensor, pressure switch, plunger switch, etc., that actuates in response insertion of collapsible containers 140 into receptacles 112. Thus, e.g., when a delivery service inserts collapsible containers 140 into receptacles 112, container detection sensor 190 generates a container detection signal. Controller 180 may receive the container detection signal from container detection sensor 190, and controller 180 may transmit a delivery notification to second user interface 186 via network interface 182. Thus, a recipient of delivered collapsible containers 140 may be advantageously alerted when the delivery service inserts collapsible containers 140 into receptacles 112.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A temperature controlled container storage system, comprising:
a cabinet defining a plurality of receptacles;
a sealed system disposed within the cabinet, the sealed system operable to chill or warm one or more of the plurality of receptacles;
a door mounted to the cabinet, the door adjustable between an open position and a closed position, the door blocking access to the plurality of receptacles in the closed position;
a latch operable to lock the door in the closed position;
a plurality of collapsible containers shaped such that each container of the plurality of collapsible containers is complementary to and receivable within a respective one of the plurality of receptacles,
wherein each container of the plurality of collapsible containers is adjustable between an unfolded configuration and a collapsed configuration, a height of each container of the plurality of collapsible containers in the unfolded configuration being greater than the height of each container of the plurality of collapsible containers in the collapsed configuration.

2. The temperature controlled container storage system of claim 1, wherein the plurality of receptacles comprises a chilled receptacle and an ambient receptacle, the sealed system operable to chill the chilled receptacle.

3. The temperature controlled container storage system of claim 1, wherein the plurality of receptacles comprises a freezer receptacle, a refrigerated receptacle and an ambient receptacle, the sealed system operable to chill the freezer receptacle to a temperature less than the freezing temperature of water, the sealed system operable to chill the refrigerated receptacle to a temperature greater than the freezing temperature of water and less than an ambient temperature about the cabinet.

4. The temperature controlled container storage system of claim 1, wherein each container of the plurality of collapsible containers is commonly sized.

5. The temperature controlled container storage system of claim 4, wherein each receptacle of the plurality of receptacles is no greater than two cubic feet, each container of the plurality of collapsible containers defines an internal storage volume in the unfolded configuration, each container of the plurality of collapsible containers sized to fit within the respective one of the plurality of receptacles in the unfolded configuration.

6. The temperature controlled container storage system of claim 1, further comprising a controller and a network interface, the controller in operative communication with the latch, the controller configured for unlocking the latch in response to an opening signal from the network interface.

7. The temperature controlled container storage system of claim 1, further comprising a controller and a network interface, the controller in operative communication with the sealed system, the controller configured for activating the sealed system in response to an activation signal from the network interface.

8. The temperature controlled container storage system of claim 7, wherein the network interface is configured to transmit a temperature of the one or more of the plurality of receptacles chilled by the sealed system to a remote device via a network.

9. The temperature controlled container storage system of claim 1, further comprising a controller, a network interface and a container detection sensor, the controller in operative communication with the container detection sensor, the controller configured for transmitting a delivery notification to a remote device via a network in response to a container detection signal from the container detection sensor.

10. The temperature controlled container storage system of claim 1, wherein each container of the plurality of collapsible containers comprises an embedded tag that is operable to transmit storage condition information.

11. The temperature controlled container storage system of claim 10, wherein the embedded tag is a radio frequency identification tag or a near field communication tag.

12. The temperature controlled container storage system of claim 1, wherein each container of the plurality of collapsible containers defines a handle.

13. The temperature controlled container storage system of claim 1, wherein the plurality of collapsible containers is stackable on one another.

14. The temperature controlled container storage system of claim 1, wherein the plurality of collapsible containers comprises a chilled receptacle container, the chilled receptacle container having insulated walls.

15. The temperature controlled container storage system of claim 1, wherein the height of each container of the plurality of collapsible containers in the unfolded configuration being at least four times greater than the height of each container of the plurality of collapsible containers in the collapsed configuration.

16. A temperature controlled container storage system, comprising:
a cabinet defining a plurality of receptacles with a refrigerated receptacle and a freezer receptacle;
a sealed system disposed within the cabinet, the sealed system operable to chill the freezer receptacle to a temperature less than the freezing temperature of water, the sealed system operable to chill the refrigerated receptacle to a temperature greater than the freezing temperature of water and less than an ambient temperature about the cabinet;
a door mounted to the cabinet, the door adjustable between an open position and a closed position, the door blocking access to the plurality of receptacles in the closed position;
a latch operable to lock the door in the closed position;
a plurality of collapsible containers comprising a refrigerated container and a freezer container, the plurality of collapsible containers commonly sized and shaped such that each container of the plurality of collapsible containers is complementary to and receivable within a respective one of the plurality of receptacles,
wherein each container of the plurality of collapsible containers is adjustable between an unfolded configuration and a collapsed configuration, a height of each container of the plurality of collapsible containers in the unfolded configuration being at least four times greater than the height of each container of the plurality of collapsible containers in the collapsed configuration, and
wherein each receptacle of the plurality of receptacles has a volume no greater than two cubic feet, each container of the plurality of collapsible containers defines an internal storage volume in the unfolded configuration, each container of the plurality of collapsible containers sized to fit within the respective one of the plurality of receptacles in the unfolded configuration.

17. The temperature controlled container storage system of claim 16, further comprising a controller and a network interface, the controller in operative communication with the latch, the controller configured for unlocking the latch in response to an opening signal from the network interface.

18. The temperature controlled container storage system of claim 16, further comprising a controller and a network interface, the controller in operative communication with the sealed system, the controller configured for activating the sealed system in response to an activation signal from the network interface.

19. The temperature controlled container storage system of claim 16, further comprising a controller, a network interface and a container detection sensor, the controller in operative communication with the container detection sensor, the controller configured for transmitting a delivery notification to a remote device via a network in response to a container detection signal from the container detection sensor.

20. The temperature controlled container storage system of claim 16, wherein each container of the plurality of collapsible containers comprises an embedded tag that is operable to transmit storage condition information.
